(19) United States
(12) Patent Application Publication
(10) Pub. No.: US 2020/0267093 A1
(43) Pub. Date: Aug. 20, 2020

(54) NETWORK CONTROL DEVICE, METHOD FOR MANAGING RESOURCES OF VIRTUAL NETWORK AND NETWORK SYSTEM

(71) Applicant: NEC Corporation

(72) Inventor: Daisuke KAMACHI, Tokyo (JP)

(73) Assignee: NEC Corporation, Minato-ku, Tokyo (JP)

(21) Appl. No.: 16/061,439

(22) PCT Filed: Dec. 16, 2016
(86) PCT No.: PCT/JP2016/087555

§ 371 Date: Jun. 12, 2018

(30) Foreign Application Priority Data
Dec. 22, 2015 (JP) 2015-250311

(51) Int. Cl. H04L 12/911; H04L 12/919; H04L 12/26; H04L 12/46

(52) U.S. Cl. CPC H04L 47/781; H04L 47/765; H04L 12/4641; H04L 43/0805; H04L 43/0888; H04L 47/822

(57) ABSTRACT

In order to provide a network control device with which it is possible to respond in real time to a sudden increase or decrease in traffic, the network control device has a user information acquisition unit 10a for acquiring, from each of a plurality of portable terminals accommodated by a virtual network, user information with which it is possible to specify the present position of the portable terminals and a resource management unit 10b for managing the resources of the virtual network on the basis of the user information acquired from each of the plurality of portable terminals.

### TECHNICAL FIELD

The present invention relates to a technique of managing resources of a virtual network.

### BACKGROUND ART

A network system to which a network function virtualization (NFV) technique is applied has been studied. The NFV technique is a technique of virtually constructing a plurality of logically independent network functions on a physical network.

As one example of the network system to which the NFV technique is applied, there is a network system described in PTL 1. This network system includes a plurality of network nodes, a plurality of servers, and a network control device that controls a network constituted by these network nodes and servers.

Each server constructs at least one virtual network function. The network control device generates extended topology in which virtual network functions that can be deployed in respective servers are added as extended nodes to topology of the network. When at least one virtual network function is requested, the network control device searches for the shortest path in the extended topology, based on resource information of the network and computing resource information of the servers. Then, based on the shortest path, the network control device determines deployment of the virtual network functions to the servers and setting of a path in the network, all together.

In connection with the present invention, PTL 2 describes a network device that changes the number of links, depending on the optimum number of links. PTL 3 describes a method of generating station data, based on past actual information.

### CITATION LIST

### Patent Literature

[PTL 1] International Publication No. WO2015/118875

[PTL 2] Japanese Unexamined Patent Application Publication No. 2010-206245

[PTL 3] Japanese Unexamined Patent Application Publication No. 2010-010904

### SUMMARY OF INVENTION

### Technical Problem

However, since the network system described in PTL 1 cannot cope with a rapid increase or decrease in traffic in real time, there are cases where resources of the virtual network cannot be efficiently used.

For example, in a large-scale marathon event where tens of thousands of runners participate, prior to the start, many runners and supporters make telephone calls, access to the Internet, writing in social networking service (SNS), and the like by using portable terminals or the like. Even after the start, many runners make communication with the supporters, checking of lap time, and the like via a network by using the portable terminals or the like. Further, many supporters move with the runners, and transmit or receive information via a network by using the portable terminals or the like, in the middle of the movement or at a movement destination. Under such a circumstance, a rapid increase or decrease in traffic occurs in part of a communication area including a marathon course, and furthermore, an occurrence position of the area of the rapid increase or decrease in traffic shifts as time elapses.

In the area of a rapid increase in traffic, a processing load increases due to lack of resources of a virtual network, and as a result, a communication speed decreases.

When resources of the virtual network are set in such a way as to be able to cover the maximum traffic over the entire communication area throughout a holding time zone of the marathon event, it is possible to suppress a decrease in a communication speed due to the above-described lack of resources. However, in this case, in an area where a rapid increase in traffic does not occur, resources of the virtual network are excessively provided. The provision of excessive resources sometimes causes an increase in power consumption of a server.

An object of the present invention is to provide a network control device, a method for managing virtual network resources, a program, a network system, and a server that are capable of coping with a rapid increase or decrease in traffic in real time.

### Solution to Problem

In order to accomplish the above-described object, according to the present invention, there is provided a network control device to be communicably connected to at least one server that construct a virtual network on a physical network, the network control device including: a user information acquisition unit that acquires, from each of a plurality of portable terminals accommodated in the virtual network, user information that enables to specify a current position of the portable terminal; and a resource management unit that manages resources of the virtual network, based on the user information acquired from each of the plurality of portable terminals.

According to the present invention, there is provided a method for managing resources of a virtual network constructed on a physical network, the method including: acquiring, from each of a plurality of portable terminals accommodated in the virtual network, user information that enables to specify a current position of the portable terminal; and managing resources of the virtual network, based on the user information.

According to the present invention, there is provided a program for managing resources of a virtual network constructed on a physical network, the program causing a computer to perform processing of: acquiring, from each of a plurality of portable terminals accommodated in the virtual network, user information that enables to specify a current position of the portable terminal; and managing resources of the virtual network, based on the user information.

According to the present invention, there is provided a network system including: at least one server that constructs a virtual network on a physical network; a network node that accommodates a plurality of portable terminals in the virtual network; and a network control device that manages resources of the virtual network, based on user information that is transmitted by each of the plurality of portable terminals and enables to specify a current position of the portable terminal.

According to the present invention, there is provided a server including: a network function virtualization unit that constructs a virtual network on a physical network; a user information acquisition unit that acquires, from each of a plurality of portable terminals accommodated in the virtual network, user information that enables to specify a current position of the portable terminal; and a resource management unit that manages resources of the virtual network, based on the user information acquired from the plurality of portable terminals.

### Advantageous Effects of Invention

According to the present invention, a rapid increase or decrease in traffic can be coped with in real time, thereby enabling efficient use of resources of a virtual network.

### BRIEF DESCRIPTION OF DRAWINGS

FIG. 1 is a block diagram illustrating a configuration of a network system according to one example embodiment of the present invention.

FIG. 2 is a block diagram illustrating a configuration of a server of the network system illustrated in FIG. 1.

FIG. 3 is a schematic diagram illustrating one example of a network function that can be provided by a network function virtualization unit of the server illustrated in FIG. 2.

FIG. 4 is a block diagram illustrating a configuration of a network control device of the network system illustrated in FIG. 1.

FIG. 5 is a flowchart illustrating one procedure of a method for managing resources of a virtual network according to the present invention.

FIG. 6 is a diagram illustrating one example of a table that represents a relation between threshold values and the numbers of virtual units.

FIG. 7 is a schematic diagram for illustrating a relation between partial communication areas, a virtual network resource management unit, and a user information storage unit.

FIG. 8 is a diagram for illustrating one example of operation of controlling the number of active virtual nodes of a server, based on a prediction result.

FIG. 9 is a diagram for illustrating one example of operation of controlling the number of active virtual nodes of a server, based on the number of accommodated terminals.

### DESCRIPTION OF EMBODIMENTS

Next, an example embodiment of the present invention will be described with reference to the drawings.

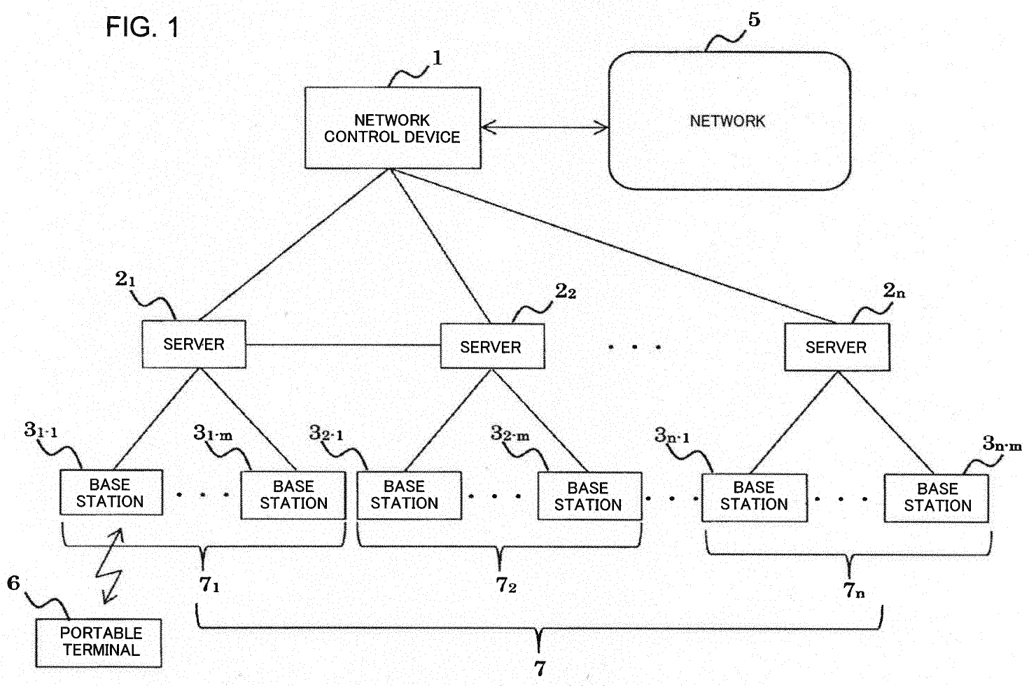

FIG. 1 is a block diagram illustrating a configuration of a network system according to one example embodiment of the present invention.

Referring to FIG. 1, the network system is a network system to which network function virtualization (NFV) technique is applied, and includes a network control device 1, servers 2₁ to 2ₙ, base stations 3₁₋₁ to and a plurality of portable terminals 6. Note that only one portable terminal 6 is illustrated in FIG. 1 for convenience.

Each of the n (n≥1) servers 2₁ to 2ₙ has a function of constructing a virtual network on a physical network (a function of virtualizing network functions). The management-target communication area 7 where the base stations 3₁₋₁ to 3ₙ₋ₘ are installed is sectioned into n partial communication areas 7₁ to 7ₙ, and the servers 2₁ to 2ₙ are arranged in such a way as to be in one-to-one correspondence with the partial communication areas 7₁ to 7ₙ, respectively. The management-target communication area 7 is a communication area including an entire marathon course, for example. The number of the servers n can be appropriately set based on a processing capacity (e.g., the maximum accommodation number of portable terminals that can be processed in the virtual network) of the server and the predicted accommodation number of the portable terminals accommodated in the management-target communication area 7. The base stations 3₁₋₁ to 3ₙ₋ₘ are divided into n base station groups 3₁₋₁ to 3₁₋ₘ, 3₂₋₁ to 3₂₋ₘ, . . . , and 3ₙ₋₁ to 3ₙ₋ₘ. The base station groups 3₁₋₁ to 3₁₋ₘ, 3₂₋₁ to 3₂₋ₘ, . . . , and 3ₙ₋₁ to 3ₙ₋ₘ, are in one-to-one correspondence with the partial communication areas 7₁ to 7ₙ, respectively. The servers 2₁ to 2ₙ accommodate base station groups 3₁₋₁ to 3₁₋ₘ, 3₂₋₁ to 3₂₋ₘ, . . . , 3ₙ₋₁ to 3ₙ₋ₘ, respectively.

Each of the base stations 3₁₋₁ to 3ₙ₋ₘ, is a network node constituting a physical network, and accommodates a plurality of portable terminals 6 in a virtual network. For example, various network nodes (physical nodes) such as a mobility management entity (MME), a home subscriber server (HSS), a policy and charging rules function (PCRF), a serving gateway (S-GW), and a packet data network gateway (P-GW), which are not illustrated in FIG. 1, may be appropriately provided in the physical network.

Each of the base stations 3₁₋₁ to 3ₙ₋ₘ, has a communication area, and performs wireless communication with the portable terminals 6 in this communication area. For example, when the present example embodiment is applied to a long term evolution (LTE) communication network or the like, the base stations 3₁₋₁ to 3ₙ₋ₘ can be referred to as an eNode (eNB).

The portable terminal 6 can access the network 5 via one of the base stations 3₁₋₁ to 3ₙ₋ₘ. The network 5 is an Internet protocol (IP) network represented by the Internet. As the portable terminal 6, a cellular phone, a smartphone, an information terminal (including a tablet terminal, a notebook type personal computer, and the like) with a communication function, or the like can be used.

The portable terminal 6 has a function of transmitting, to a previously designated destination address, user information that enables to specify a current position of the portable terminal itself, together with identification information (or user identification information) of the portable terminal itself. Herein, for example, the user information is lap time information indicating time taken for each predetermined distance, current position information (GPS position information) acquired by using the global positioning system (GPS), and the like. Techniques of transmitting lap time information and GPS position information are well known, and these techniques are applied also in the present example embodiment. The destination address may include identification information using an IP address, a media access control (MAC) address, or the like.

The network control device 1 is connected to each of the servers 2₁ to 2ₙ in such a way as to enable mutual communication. The network control device 1 has a function of managing resources of the virtual network, based on the user information transmitted by a plurality of the respective portable terminals 6 accommodated in the virtual network. The network control device 1 can acquire the user information transmitted by the portable terminals 6, via the network 5. For example, as the network control device 1, a software-defined network (SDN) service controller can be applied.

Next, a specific configuration of the servers 2₁ to 2ₙ will be described.

Each of the servers 2₁ to 2ₙ has the same configuration. Hereinafter, the servers 2₁ to 2ₙ are collectively referred to as the servers 2.

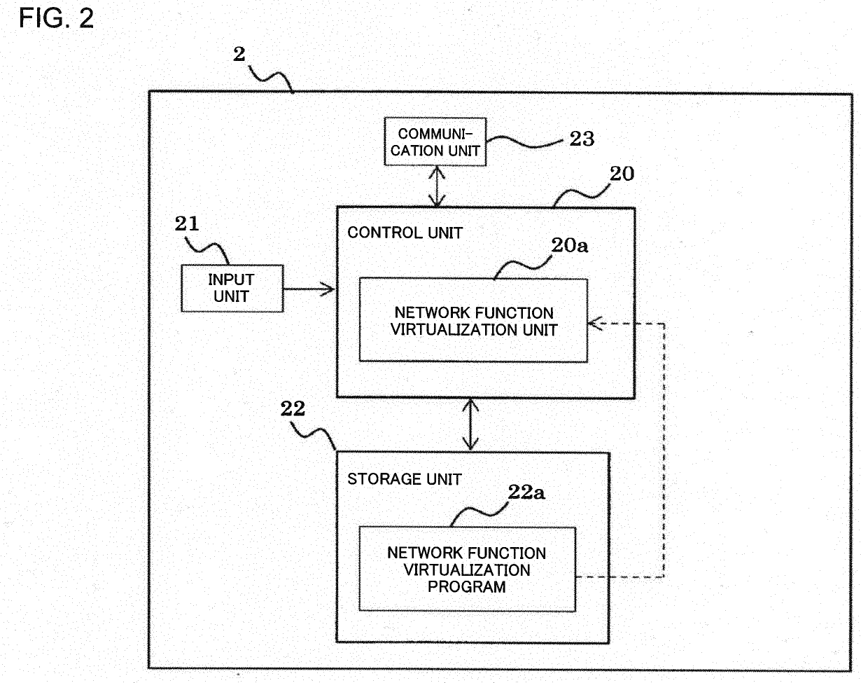

FIG. 2 is a block diagram illustrating the configuration of the server 2. Referring to FIG. 2, the server 2 includes a control unit 20, an input unit 21, a storage unit 22, and a communication unit 23.

The input unit 21 includes an operation unit such as an operation button and a keyboard, and supplies to the control unit 20, an operation signal associated with an input operation made by an operator using the operation unit.

The storage unit 22 stores programs and data necessary for operating the server 2. As one of the programs, a network function virtualization program 22a is stored in the storage unit 22. As the storage unit 22, a semiconductor memory, a hard disk, or the like can be used. The semiconductor memory includes a volatile memory represented by a random access memory (RAM), and a nonvolatile memory represented by a read only memory (ROM).

The network function virtualization program 22a is a program for virtually constructing various network functions such as an MME, an HSS, a PCRF, an S-GW, and a P-GW. The network function virtualization program 22a may be provided via a computer-readable recording medium or a communication network (e.g., the Internet). For example, the recording medium is an optical disk such as a compact disc (CD) or a digital versatile disc (DVD), a magnetic disc, a universal serial bus (USB) memory, a memory card, or the like.

The communication unit 23 includes a first communication unit that communicates with one of the base stations 3₁₋₁ to and a second communication unit that communicates with the network control device 1.

The control unit 20 includes a central processing unit (CPU). The control unit 20 executes the program stored in the storage unit 22, and performs various processes, depending on an operation signal from the input unit 21. For example, the CPU executes the network function virtualization program 22a, and thereby provides the network function virtualization unit 20a capable of virtually constructing various network functions such as an MME, an HSS, a PCRF, an S-GW, and a P-GW.

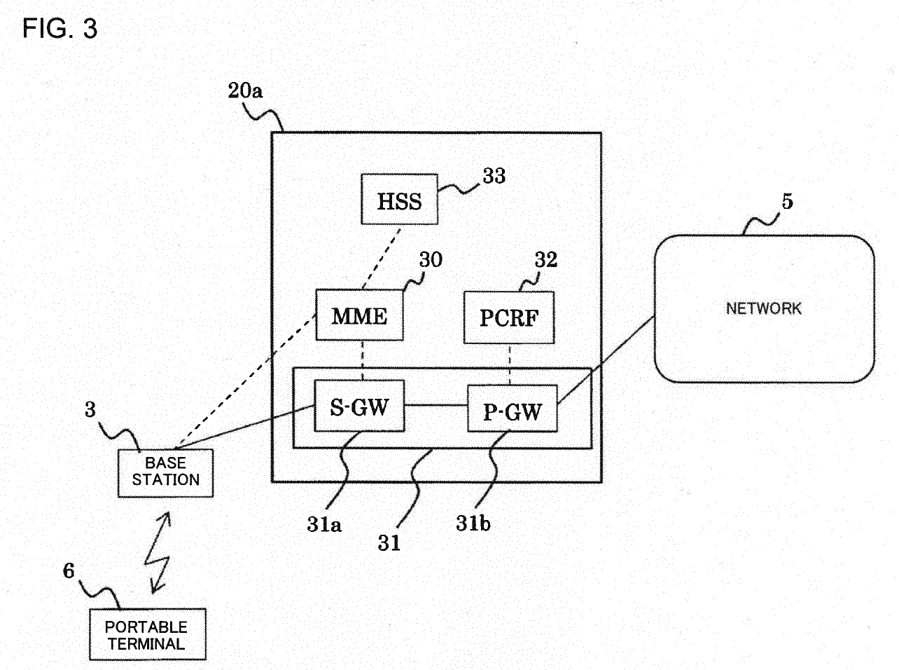

FIG. 3 schematically illustrates network functions that can be provided by the network function virtualization unit 20a. In FIG. 3, the base station 3 is a general term for the base stations 3₁₋₁ to 3ₙ₋ₘ.

As illustrated in FIG. 3, the network function virtualization unit 20a can construct virtual nodes such as an MME 30, a GW 31, a PCRF 32, and an HSS 33 on the physical network. The GW 31 includes an S-GW 31a and a P-GW 31b.

A GPRS tunneling protocol (GTP) tunnel is formed between the base station 3 and the S-GW 31a and between the S-GW 31a and the P-GW 31b. GPRS is an abbreviation for “general packet radio service”. When the portable terminal 6 connected to the base station 3 is connected to the network 5 via the GTP tunnels, transmission and reception of data is enabled between the portable terminal 6 and an external device (such as the network control device 1, another portable terminal, or an information processing terminal).

Network functions such as an MME, an S-GW, a P-GW, a PCRF, and an HSS are well known, and those network functions are applied also in the present example embodiment. For example, the MME 30 has a mobility control function (such as a position registration function), an eUTRAN control function, an authentication-and-confidentiality function, a handover function, a path control function, and the like. The GW 31 (the S-GW 31a and the P-GW 31b) has an eUTRAN control function, a path control function, a confidentiality function, a handover function, a QoS control function, and the like. Since these functions are also well known, the detailed descriptions thereof are omitted. It is assumed in the present example embodiment that the MME 30 is a control-type node, and the GW 31 (the S-GW 31a and the P-GW 31b) is a transfer-type node, but is not limited thereto.

Note that in FIG. 3, the MME 30, the GW 31, the PCRF 32, and the HSS 33 are illustrated as virtual nodes provided by the network function virtualization unit 20a, but are not limited thereto. The virtual nodes provided by the network function virtualization unit 20a can be appropriately changed. For example, the network function virtualization unit 20a may provide the MME 30 and the GW 31, and other network functions may be physical nodes.

In the present example embodiment, the network function virtualization unit 20a can construct one or more virtual units including the MME 30 and the GW 31, in accordance with a control signal from the network control device 1. The number and combination of the MMEs 30 and the GWs 31 constituting the virtual units can be appropriately set depending on a communication environment (e.g., a traffic change).

Next, a specific configuration of the network control device 1 will be described.

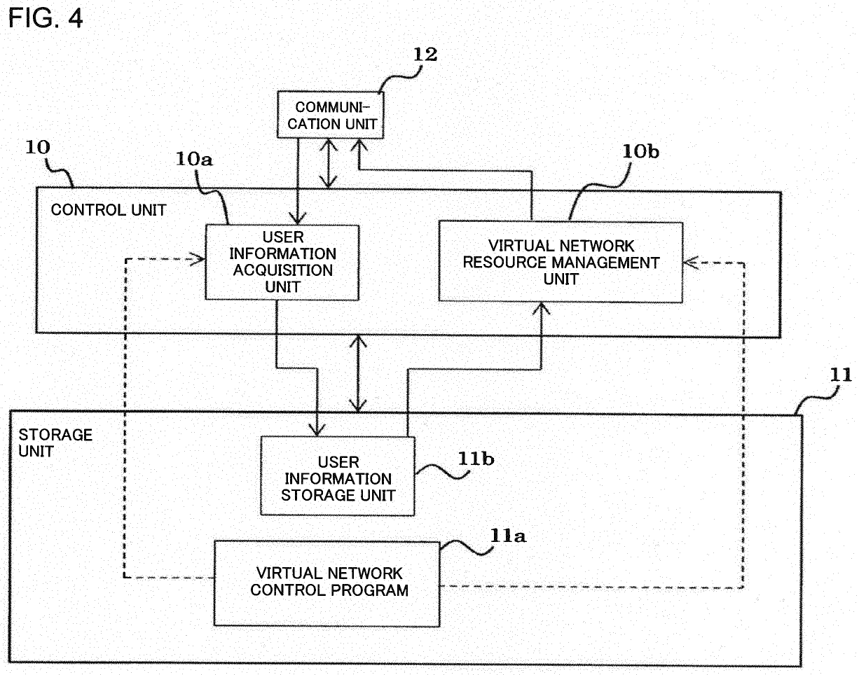

FIG. 4 is a block diagram illustrating the configuration of the network control device 1. Referring to FIG. 4, the network control device 1 includes a control unit 10, a storage unit 11, and a communication unit 12.

The storage unit 11 stores programs and data necessary for operating the network control device 1. As one of the programs, a virtual network control program 11a is stored in the storage unit 11. Further, the storage unit 11 includes a user information storage unit 11b for collecting user information. As the storage unit 11, a semiconductor memory, a hard disk, or the like can be used. The semiconductor memory includes a volatile memory represented by a RAM and a nonvolatile memory represented by a ROM.

The communication unit 12 includes a first communication unit that communicates with the respective servers 2₁ to 2ₙ, and a second communication unit that communicates with an external device (the portable terminal 6, another terminal, or the like) via the network 5. The user information from the portable terminal 6 is received by the second communication unit of the communication unit 12 via the network 5.

The virtual network control program 11a is a program for collecting the user information transmitted by each of a plurality of the portable terminals 6 accommodated in the virtual network, and controlling resources of the virtual network, based on the collected user information. The virtual network control program 11a may be provided via a computer-readable recording medium or a communication network (e.g., the Internet). For example, the recording medium is an optical disc such as a CD or a DVD, a magnetic disc, a USB memory, a memory card, or the like.

The control unit 10 includes a CPU, and performs various processes in accordance with the programs stored in the storage unit 12. For example, the CPU executes the virtual network control program 11a, and thereby provides a user information acquisition unit 10a and a virtual network resource management unit 10b. Herein, the virtual network control program 11a can operate in conjunction with the network function virtualization program 22a of each of the servers 2₁ to 2ₙ.

The user information acquisition unit 10a acquires, via the communication unit 12, the user information from a plurality of the portable terminals 6 accommodated in the virtual network, and stores the acquired user information in the user information storage unit 11b. The user information may be stored in the user information storage unit 11b in the time-series order, for each portable terminal (or for each user).

Based on the user information of each user stored in the user information storage unit 11b, the virtual network resource management unit 10b calculates the number of the portable terminals currently accommodated in each of the partial communication areas 7₁ to 7ₙ.

When the user information includes the GPS information, the virtual network resource management unit 10b can specify an area where the portable terminal is currently located, based on the GPS information and previously given position information of the partial communication area. When the user information includes lap time information, the virtual network resource management unit 10b can specify an area where the portable terminal is currently located, based on the time-series lap time information and map information of the course. Combining the GPS information and the time-series lap time information improves accuracy of specifying the area.

The virtual network resource management unit 10b acquires the number of the portable terminals currently accommodated in each of the partial communication areas 7₁ to 7ₙ (hereinafter, referred to as the current number of accommodated terminals), and adjusts the number of the active virtual nodes, depending on the current number of accommodated terminals, for each of the servers 2₁ to 2ₙ. For example, when the current number of accommodated terminals is equal to or more than a threshold value Th1, the number of the active virtual nodes is set at a set number A1, and when the current number of accommodated terminals is equal to or less than a threshold value Th2 (<Th1), the number of the active virtual nodes is set at a set number A2 (<A1). The number of active virtual nodes may be adjusted at predetermined time intervals.

Next, the description will be made on a method for managing resources of the virtual network in the network system according to the present example embodiment.

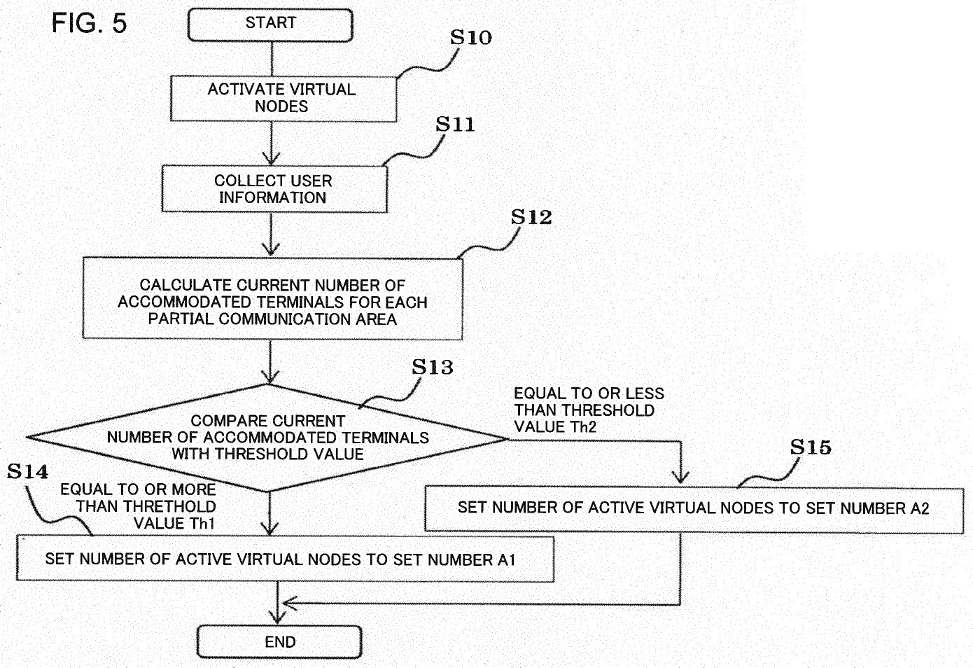

FIG. 5 is a flowchart illustrating one procedure of the method for managing resources of the virtual network. Hereinafter, the procedure of managing resources of the virtual network will be described with reference to FIG. 1 to FIG. 5.

First, in each of the servers 2₁ to 2ₙ, the network function virtualization unit 20a activates the preset number of virtual nodes in accordance with a control signal from the virtual network resource management unit 10b (step S10).

Next, in the network control device 1, the user information acquisition unit 10a collects the user information transmitted by the portable terminals 6 accommodated in the virtual network (step S11). The collected user information is stored in the user information storage unit 11b.

Next, based on the user information stored in the user information storage unit 11b, the virtual network resource management unit 10b calculates the current number of accommodated terminals in each of the partial communication areas 7₁ to 7ₙ (step S12). Then, the virtual network resource management unit 10b compares the current number of accommodated terminals with the threshold values (step S13).

When the current number of accommodated terminals is equal to or more than the threshold value Th1, the virtual network resource management unit 10b transmits, to the server of the corresponding partial communication area, a control signal for setting the number of active virtual nodes as the set number A1. In accordance with the control signal, the network function virtualization unit 20a sets the number of active virtual nodes as the set number A1, in the server (step S14).

When the current number of accommodated terminals is equal to or less than the threshold value Th2, the virtual network resource management unit 10b transmits, to the server of the corresponding partial communication area, a control signal for setting the number of active virtual nodes as the set number A2. In accordance with the control signal, the network function virtualization unit 20a sets the number of active virtual nodes as the set number A2, in the server (step S15).

According to the above-described method for managing resources of the virtual network, in the partial communication area where a rapid increase in traffic occurs, the current number of accommodated terminals becomes equal to or more than the threshold value Th1, and thus, the number of active virtual nodes increases. This enables to suppress a decrease in a communication speed due to lack of resources.

Meanwhile, in the partial communication area where a rapid decrease in traffic occurs, the current number of accommodated terminals becomes equal to or less than the threshold value Th2, and thus, the number of active virtual nodes decreases. This enables to suppress an increase in power consumption of the server due to provision of excessive resources.

The above-described configuration and operation of the network system according to the present example embodiment is merely one example, and can be appropriately modified.

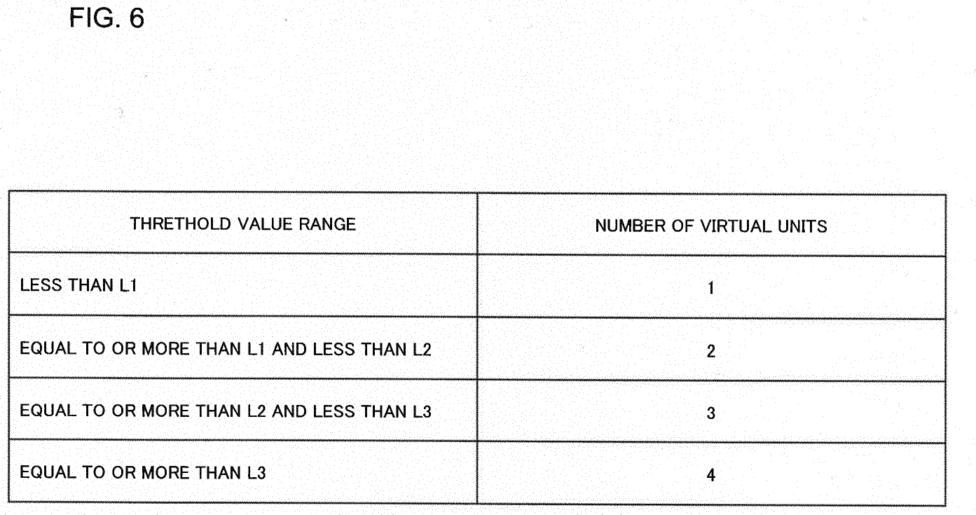

For example, the virtual network resource management unit 10b may increase or decrease the number of active virtual nodes stepwisely, depending on the current number of accommodated terminals. For example, the virtual network resource management unit 10b holds a table representing a relation between threshold values and the numbers of virtual units, such as that illustrated in FIG. 6. According to the table, when the current number of accommodated terminals is less than the threshold value L1, the number of active virtual nodes is set to one. When the current number of accommodated terminals is equal to or more than the threshold value L1 and less than the threshold value L2, the number of the active virtual nodes is set to two. When the current number of accommodated terminals is equal to or more than the threshold value L2 and less than the threshold value L3, the number of active virtual nodes is set to three. When the current number of accommodated terminals is equal to or more than the threshold value L3, the number of active virtual nodes is set to four. The current number of accommodated terminals can be compared with the threshold values at predetermined time intervals. The threshold values L1 to L3 are appropriately set based on processing capacities and the number of virtual units. Note that the number of the threshold values is not limited to three. The number of threshold values may be four or more.

In FIG. 1, each of the servers 2₁ to 2ₙ may be configured in such a way as to be able to communicate with each of the base stations 3₁₋₁ to 3ₙ₋ₘ. In this case, the virtual network resource management unit 10b appropriately assigns, to the partial communication areas 7₁ to 7ₙ, the virtual units constructed by each of the servers 2₁ to 2ₙ. Then, the virtual network resource management unit 10b increases the number of active virtual units for the partial communication area where a rapid increase in traffic occurs, and decreases the number of active virtual units for the partial communication area where a rapid decrease in traffic occurs. According to this configuration, the number of active virtual units can be adjusted between the partial communication areas 7₁ to 7ₙ, depending on a traffic increase or decrease, while the number of virtual units in the entire management-target communication area 7 remains constant. Therefore, resources of the virtual network can be used efficiently.

In FIG. 1, when one server can cover a management-target communication area, the functions corresponding to the network control device 1 may be incorporated in the server. When a plurality of servers cover a management-target communication area, a main server may be set, and the functions corresponding to the network control device 1 may be incorporated in this server.

The user information may be provided to the network control device 1 via one of the servers 2₁ to 2ₙ. In this case, each of the servers 2₁ to 2ₙ has a function of providing, to the network control device 1, the user information from the portable terminal 6.

The virtual network resource management unit 10b may predict the number of accommodated terminals in the partial communication area, based on information of the time-sesies numbers of accommodated terminals, and may determine the number of active virtual nodes, based on the prediction result.

### Example

Next, the description will be made on the operation of the network system according to the present example embodiment as well as actions and effects thereof when the network system according to the present example embodiment is applied to a large scale marathon event of 30,000 runners and a million roadside supporters.

The communication area including a marathon course is the management-target communication area 7, and the management-target communication area 7 is sectioned into four partial communication areas 7₁ to 7₄. The partial communication area 7 is a section area from a start spot to a 10 km spot. The partial communication area 7₂ is a section area from the 10 km spot to a 20 km spot. The partial communication area 7₃ is a section area from the 20 km spot to a 30 km spot. The partial communication area 7₄ is a section area from the 30 km spot to a goal spot. The servers 2ᵢ to 2₄ are arranged in one-to-one correspondence with the partial communication areas 7ᵢ to 7₄, respectively.

Based on an estimated runner's whole-distance running time acquired in advance, occurrence position and occurrence time of an area of a rapid increase or decrease in traffic, and the number of accommodated terminals are predicted, and a result of the prediction is given to the virtual network resource management unit 10b in advance. Based on the prediction result, the virtual network resource management unit 10b controls an increase or decrease of the number of active virtual nodes of each of the servers 2₁ to 2₄, and performs the method for managing resources of the virtual network illustrated in FIG. 5. Herein, the lap time information is used as the user information.

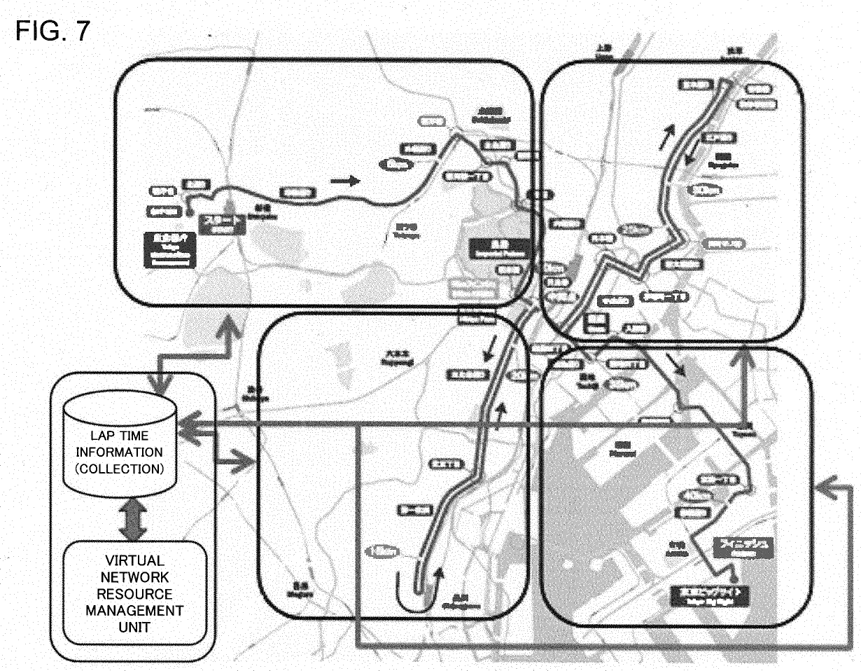

FIG. 7 schematically illustrates a relation between the partial communication areas 7₁ to 7₄ and the virtual network resource management unit 10b and the user information storage unit 11b.

Prior to the start, the user information storage unit 11b stores the numbers of runners in the partial communication areas 7₁ to 7₄ based on the prediction result, in each time zone. The numbers (prediction) of runners in each time zone in the partial communication areas 7₁ to 7₄ are as follows.

### Partial Communication Area 7₁

From 8:00 to 9:00: 30,000 people

From 9:00: 0 people

### Partial Communication Area 7₂

From 8:00 to 9:00: 9,000 people

From 9:00 to 10:00: 21,000 people

From 10:00: 0 people

### Partial Communication Area 7₃

From 8:00 to 9:00: 0 people

From 9:00 to 10:00: 6,000 people

From 10:00 to 11:00: 21,000 people

From 11:00 to 12:00: 12,000 people

From 12:00: 0 people

### Partial Communication Area 7₄

From 8:00 to 9:00: 0 people

From 9:00 to 10: 00: 2,000 people

From 10:00 to 11:00: 6,000 people

From 11:00 to 12:00: 14,000 people

From 13:00: 30,000 people

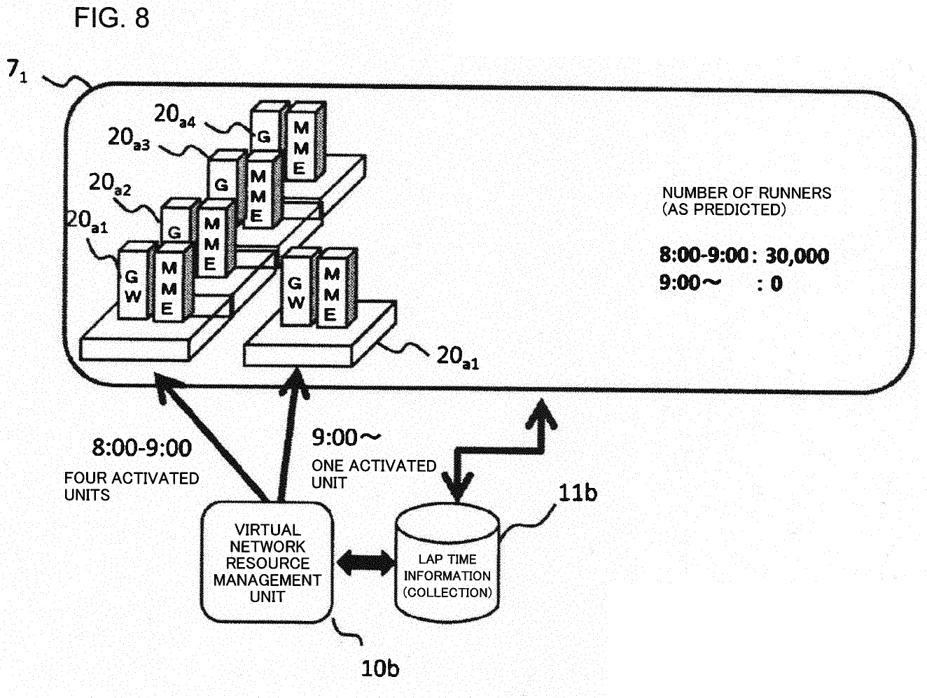

FIG. 8 schematically illustrates increase or decrease operation of virtual units that is performed for the server 2₁ arranged in the partial communication area 7ᵢ. Herein, it is assumed that a processing capacity of a single virtual unit can handle 400,000 people. Herein, it is assumed that a threshold value Th is 20,000 (the number of runners), four virtual units are made active in the case of being equal to or more than the threshold value Th, and one virtual unit is made active in the case of being less than the threshold value Th.

As predicted, in the partial communication area 7₁, the number of runners in the time zone from 8:00 to 9:00 is 30,000, and the number of runners in the time zone after 9:00 is 0. Accordingly, based on the prediction result, the virtual network resource management unit 10b controls an increase or decrease of the number of active virtual nodes of the server 2₁ as follows.

In the time zone from 8:00 to 9:00, resources corresponding to 1,030,000 people that are 30,000 runners plus 1,000,000 roadside supporters are managed. Since the number of the runners is equal to or more than the threshold value Th, the virtual network resource management unit 10b supplies, to the network function virtualization unit 20a of the server 2₁, a control signal for causing four virtual units to be activated. In the server 2₁, the network function virtualization unit 20a activates four virtual units 20a1 to 20a4, in accordance with the control signal from the virtual network resource management unit 10b.

In the time zone after 9:00, since the number of runners is zero, the number of roadside supporters can be estimated to be zero, as well. Since the number of runners is less than the threshold value Th, the virtual network resource management unit 10b supplies, to the network function virtualization unit 20a of the server 2₁, a control signal for causing one virtual unit to be activated. In the server 2₁, the network function virtualization unit 20a activates one virtual unit 20a1, in accordance with the control signal from the virtual network resource management unit 10b.

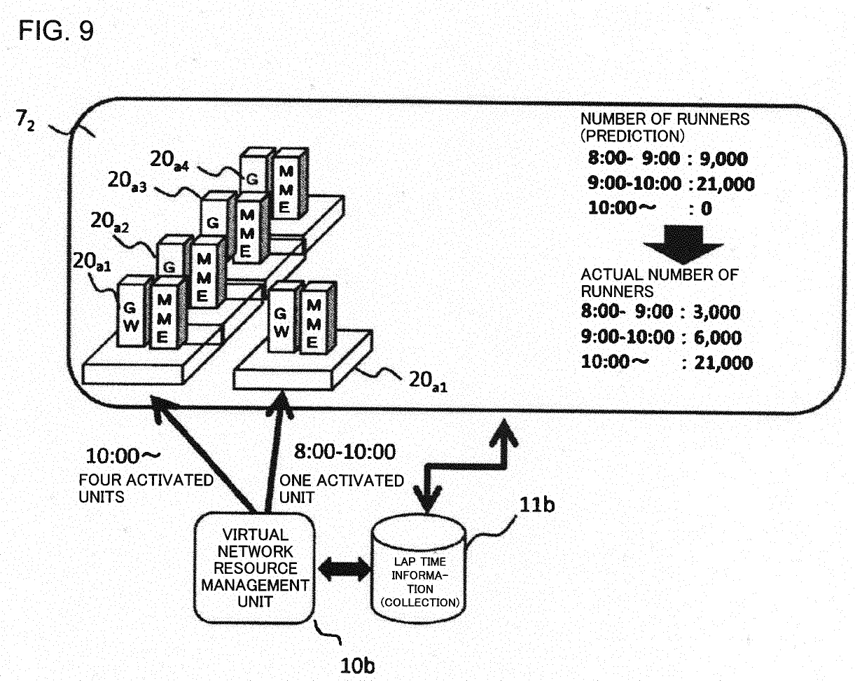

FIG. 9 schematically illustrates increase or decrease operation of virtual units that is performed for the server 2₂ arranged in the partial communication area 7₂.

In the partial communication area 7₂, paces of runners drop due to a temperature rise, and the actual number of runners largely deviates from the predicted number of people. Thus, the virtual network resource management unit 10b controls an increase or decrease of the number of active virtual nodes of the server 2₂based on an increase or decrease in traffic, as follows.

The number of runners in the time zone from 8:00 to 9:00 is 3,000, the number of runners in the time zone from 9:00 to 10:00 is 6,000, and the number of runners in the time zone after 10:00 is 21,000. It is assumed that the number of roadside supporters increases or decreases in proportion to the number of runners, and is set at a value acquired by multiplying the number of runners by a predetermined value (e.g., 30 times).

In the time zone from 8:00 to 9:00, the number of runners is 3,000, and thus, the number of people does not reach 400,000 even when roadside supporters are added. Since the number of runners is less than the threshold value Th, the virtual network resource management unit 10b supplies, to the network function virtualization unit 20a of the server 2₂, a control signal for causing one virtual unit to be activated. In the server 2₂, the network function virtualization unit 20a activates one virtual unit 20a1, in accordance with the control signal from the virtual network resource management unit 10b.

In the time zone from 9:00 to 10:00, the number of runners is 6,000, and thus, the number of people does not reach 400,000 even when roadside supporters are added. Since the number of runners is less than the threshold value Th, the virtual network resource management unit 10b supplies, to the network function virtualization unit 20a of the server 2₂, a control signal for causing one virtual unit to be activated. In the server 2₂, the network function virtualization unit 20a activates one virtual unit 20a1, in accordance with the control signal from the virtual network resource management unit 10b.

In the time zone after 10:00, the number of runners is 21,000, and the number of people exceeds 400,000 when roadside supporters are added. Since the number of runners is equal to or more than the threshold value Th, the virtual network resource management unit 10b supplies, to the network function virtualization unit 20a of the server 2₂, a control signal for causing four virtual unit to be activated. In the server 2₂, the network function virtualization unit 20a activates four virtual units 20a1 to 20a4, in accordance with the control signal from the virtual network resource management unit 10b.

For the partial communication areas 7₃ and 7₄, since the actual numbers of runners largely deviate from the predicted numbers of people, the virtual network resource management unit 10b controls an increase or decrease of the numbers of active virtual nodes of the server 2₂based on an increase or decrease in the traffic, as well.

According to the present example, the lap time information managed by a runner using the the portable terminal is collected via the network, and actual position information of the runner is obtained. Based on the lap time information, the area of a rapid increase or decrease in network traffic on the day of the event is updated in real time.

Further, assuming that runners (30,000 people) and supporters (1,000,000 people) move 10 km every two hours, and the management-target communication area is divided into four unit areas of approximately 10 km. Even when traffic in one partial communication area among the four partial communication areas is in a congested state, a normal operation mode can be used in the remaining three partial communication areas. Localizing an influence of the congested state enables efficient allocation of traffic.

Although the operation is described above by citing the marathon event as an example, the present invention is not limited to this. The present invention can be applied to various cases such as a race, touring, using bicycles, motorcycles, or cars.

Further, the present invention can be applied also to the field of NW resource management for a measure against a rapidly increase in local network traffic in an event or the like where a density of people temporarily and rapidly increases.

Recently, a network system using a virtualized evolved packet core (vEPC) as a core of LTE communication has been provided, and this system can be applied to the present invention.

The present invention may take forms described in the following supplementary notes 1 to 26, but is not limited to these forms.

### Supplementary Note 1

A network control device to be communicably connected to at least one server that constructs a virtual network on a physical network, including:

a user information acquisition unit that acquires, from each of a plurality of portable terminals accommodated in the virtual network, user information that enables to specify a current position of the portable terminal; and

a resource management unit that manages resources of the virtual network, based on the user information acquired from each of the plurality of portable terminals.

### Supplementary Note 2

The network control device according to the supplementary note 1, wherein based on the user information acquired from the plurality of portable terminals, the resource management unit adjusts the number of active virtual units constituting the virtual network.

### Supplementary Note 3

The network control device according to the supplementary note 2, wherein the resource management unit calculates the number of portable terminals accommodated in a predetermined communication area, based on the user information acquired from the plurality of portable terminals, and increases or decreases the number of active virtual units, depending on the number of accommodated portable terminals.

### Supplementary Note 4

The network control device according to the supplementary note 3, wherein the predetermined communication area is sectioned into a plurality of partial communication areas, and

the resource management unit calculates the number of accommodated portable terminals for each of the partial communication areas, and increases or decreases the number of active virtual units.

### Supplementary Note 5

The network control device according to any one of the supplementary notes 1 to 4, wherein the user information includes lap time information indicating time taken for each predetermined distance or current position information indicating a current position of the portable terminal, or includes both of the lap time information and the current position information.

### Supplementary Note 6

A method for managing resources of a virtual network constructed on a physical network, including:

acquiring, from each of a plurality of portable terminals accommodated in the virtual network, user information that enables to specify a current position of the portable terminal; and managing resources of the virtual network, based on the user information.

### Supplementary Note 7

The method for managing resources of a virtual network according to the supplementary note 6, including: adjusting the number of active virtual units constituting the virtual network, based on the user information acquired from the plurality of portable terminals.

### Supplementary Note 8

The method for managing resources of a virtual network according to the supplementary note 7, including: calculating the number of portable terminals accommodated in a predetermined communication area, based on the user information acquired from the plurality of portable terminals; and increasing or decreasing the number of active virtual units, depending on the number of accommodated portable terminals.

### Supplementary Note 9

The method for managing resources of a virtual network according to the supplementary note 8, including: sectioning the predetermined communication area into a plurality of partial communication areas; calculating the number of accommodated portable terminals for each of the partial communication areas; and increasing or decreasing the number of active virtual units.

### Supplementary Note 10

The method for managing resources of a virtual network according to any one of the supplementary notes 6 to 9, wherein the user information includes lap time information indicating time taken for each predetermined distance or current position information indicating a current position of the portable terminal, or includes both of the lap time information and the current position information.

### Supplementary Note 11

A program for managing resources of a virtual network constructed on a physical network, causing a computer to perform a process of: acquiring, from each of a plurality of portable terminals accommodated in the virtual network, user information that enables to specify a current position of the portable terminal; and managing resources of the virtual network, based on the user information.

### Supplementary Note 12

The program according to the supplementary note 11, the process including: adjusting the number of active virtual units constituting the virtual network, based on the user information acquired from the plurality of portable terminals.

### Supplementary Note 13

The program according to the supplementary note 12, the process including: calculating the number of portable terminals accommodated in a predetermined communication area, based on the user information acquired from the plurality of portable terminals; and increasing or decreasing the number of active virtual units, depending on the number of accommodated portable terminals.

### Supplementary Note 14

The program according to the supplementary note 13, the process including: sectioning the predetermined communication area into a plurality of partial communication areas; calculating the number of accommodated portable terminals for each of the partial communication areas; and increasing or decreasing the number of active virtual units.

### Supplementary Note 15

The program according to any one of the supplementary notes 11 to 14, wherein the user information includes lap time information indicating time taken for each predetermined distance or current position information indicating a current position of the portable terminal, or includes both of the lap time information and the current position information.

### Supplementary Note 16

A network system including:

at least one server constructing a virtual network on a physical network;

a network node accommodating a plurality of portable terminals in the virtual network; and

a network control device managing resources of the virtual network, based on user information that is transmitted by each of the plurality of portable terminals and enables to specify a current position of the portable terminal.

### Supplementary Note 17

The network system according to the supplementary note 16, the network control device including:

a user information acquisition unit that acquires, from each of a plurality of portable terminals accommodated in the virtual network, user information that enables to specify a current position of the portable terminal; and

a resource management unit that manages resources of the virtual network, based on the user information acquired from each of the plurality of portable terminals.

### Supplementary Note 18

The network system according to the supplementary note 17, wherein based on the user information acquired from the plurality of portable terminals, the resource management unit adjusts the number of active virtual units constituting the virtual network.

### Supplementary Note 19

The network system according to the supplementary note 18, wherein the resource management unit calculates the number of portable terminals accommodated in a predetermined communication area, based on the user information acquired from the plurality of portable terminals, and increases or decreases the number of active virtual units, depending on the number of accommodated portable terminals.

### Supplementary Note 20

The network system according to the supplementary note 19, wherein the predetermined communication area is sectioned into a plurality of partial communication areas,

the server provides at least one virtual node that is a resource of the virtual network, for each of the partial communication areas, and

the resource management unit calculates the number of accommodated portable terminals for each of the partial communication areas, and increases or decreases the number of active virtual units.

### Supplementary Note 21

The network system according to any one of the supplementary notes 16 to 20, wherein the user information includes lap time information indicating time taken for each predetermined distance or current position information indicating a current position of the portable terminal, or includes both of the lap time information and the current position information.

### Supplementary Note 22

A server including:

a network function virtualization unit that constructs a virtual network on a physical network;

a user information acquisition unit that acquires, from each of a plurality of portable terminals accommodated in the virtual network, user information that enables to specify a current position of the portable terminal; and

a resource management unit that manages resources of the virtual network, based on the user information acquired from each of the plurality of portable terminals.

### Supplementary Note 23

The server according to the supplementary note 22, wherein based on the user information acquired from the plurality of portable terminals, the resource management unit adjusts the number of active virtual units constituting the virtual network.

### Supplementary Note 24

The server according to the supplementary note 23, wherein the network function virtualization unit is configured in such a way as to be able to deploy, for a predetermined communication area, at least one virtual unit constituting the virtual network, and

the resource management unit calculates the number of portable terminals accommodated in the predetermined communication area, based on the user information acquired from the plurality of portable terminals, and increases or decreases the number of active virtual units, depending on the number of accommodated portable terminals.

### Supplementary Note 25

The server according to the supplementary note 24, wherein the predetermined communication area is sectioned into a plurality of partial communication areas, and

the resource management unit calculates the number of accommodated portable terminals for each of the partial communication areas, and increases or decreases the number of active virtual units.

### Supplementary Note 26

The server according to any one of the supplementary notes 22 to 25, wherein the user information includes lap time information indicating time taken for each predetermined distance or current position information indicating a current position of the portable terminal, or includes both of the lap time information and the current position information.

Although the present invention is described above with reference to the example embodiment and examples, the present invention is not limited to the above-described example embodiment and examples. Various modifications that can be understood by those skilled in the art can be made on a configuration and details of the present invention within the scope of the present invention.

The present patent application claims priority based on Japanese patent application No. 2015-250311 filed on Dec. 22, 2015, the disclosure of which is incorporated herein in its entirety.

### REFERENCE SIGNS LIST

1 Network control device
2, 2₁ to 2ₙ Server
3, 3₁₋₁ to 3ₙ₋ₘ Base station
6 Portable terminal
10, 20 Control unit
10a User information acquisition unit
10b Virtual network resource management unit
11, 22 Storage unit
11a Virtual network control program
11b User information storage unit
12, 23 Communication unit
20a Network function virtualization unit
22a Network function virtualization program
21 Input unit

What is claimed is:

1. A network control device to be communicably connected to at least one server configured to construct a virtual network on a physical network, the network control device comprising:
an user information acquisition circuit configured to acquire, from each of a plurality of portable terminals accommodated in the virtual network, user information that enables to specify a current position of the portable terminal; and
a resource manager configured to manage resources of the virtual network, based on the user information acquired from each of the plurality of portable terminals.

2. The network control device according to claim 1, wherein,
based on the user information acquired from the plurality of portable terminals, the resource manager adjusts a number of active virtual units constituting the virtual network.

3. The network control device according to claim 2, wherein
the resource manager calculates a number of portable terminals accommodated in a predetermined communication area, based on the user information acquired from the plurality of portable terminals, and increases or decreases the number of active virtual units, depending on the number of accommodated portable terminals.

4. The network control device according to claim 3, wherein
the predetermined communication area is sectioned into a plurality of partial communication areas, and
the resource manager calculates a number of accommodated portable terminals for each of the partial communication areas, and increases or decreases the number of active virtual units.

5. The network control device according to claim 1, wherein
the user information includes lap time information indicating time taken for each predetermined distance or current position information indicating a current position of the portable terminal, or includes both of the lap time information and the current position information.

6. A method for managing resources of a virtual network constructed on a physical network, the method comprising:
acquiring, from each of a plurality of portable terminals accommodated in the virtual network, user information that enables to specify a current position of the portable terminal; and
managing resources of the virtual network, based on the user information.

7. The method for managing resources of a virtual network according to claim 6, further comprising: adjusting a number of active virtual units constituting the virtual network, based on the user information acquired from the plurality of portable terminals.

8. The method for managing resources of a virtual network according to claim 7, further comprising:
calculating a number of portable terminals accommodated in a predetermined communication area, based on the user information acquired from the plurality of portable terminals; and
increasing or decreasing the number of active virtual units, depending on the number of accommodated portable terminals.

9. The method for managing resources of a virtual network according to claim 8, further comprising:
sectioning the predetermined communication area into a plurality of partial communication areas;
calculating a number of accommodated portable terminals for each of the partial communication areas; and
increasing or decreasing the number of active virtual units.

10. The method for managing resources of a virtual network according to claim 6, wherein
the user information includes lap time information indicating time taken for each predetermined distance or current position information indicating a current position of the portable terminal, or includes both of the lap time information and the current position information.

11-15. (canceled)

16. A network system comprising:
at least one server configured to construct a virtual network on a physical network;
a network node configured to accommodate a plurality of portable terminals in the virtual network; and
a network controller configured to manage resources of the virtual network, based on user information that is transmitted by each of the plurality of portable terminals and enables to specify a current position of the portable terminal.

17. The network system according to claim 16, wherein
the network control device includes:
an user information acquisition circuit configured to acquire, from each of a plurality of portable terminals accommodated in the virtual network, the user information that enables to specify a current position of the portable terminal; and
a resource manager configured to manage resources of the virtual network, based on the user information acquired from each of the plurality of portable terminals.

18. The network system according to claim 17, wherein,
based on the user information acquired from the plurality of portable terminals, the resource manager adjusts a number of active virtual units constituting the virtual network.

19. The network system according to claim 18, wherein
the resource manager calculates a number of portable terminals accommodated in a predetermined communication area, based on the user information acquired from the plurality of portable terminals, and increases or decreases the number of active virtual units, depending on the number of accommodated portable terminals.

20. The network system according to claim 19, wherein
the predetermined communication area is sectioned into a plurality of partial communication areas,
the server provides at least one virtual node that is a resource of the virtual network, for each of the partial communication areas, and
the resource manager calculates a number of accommodated portable terminals for each of the partial communication areas, and increases or decreases the number of active virtual units.

21. The network system according to claim 16, wherein
the user information includes lap time information indicating time taken for each predetermined distance or current position information indicating a current position of the portable terminal, or includes both of the lap time information and the current position information.

22-26. (canceled)

27. The network control device according to claim 2, wherein
the user information includes lap time information indicating time taken for each predetermined distance or current position information indicating a current position of the portable terminal, or includes both of the lap time information and the current position information.

28. The method for managing resources of a virtual network according to claim 7, wherein
the user information includes lap time information indicating time taken for each predetermined distance or current position information indicating a current position of the portable terminal, or includes both of the lap time information and the current position information.

29. The network system according to claim 17, wherein
the user information includes lap time information indicating time taken for each predetermined distance or current position information indicating a current position of the portable terminal, or includes both of the lap time information and the current position information.
